(19) United States
(12) Patent Application Publication
(10) Pub. No.: US 2009/0160862 A1
(43) Pub. Date: Jun. 25, 2009

(54) Method and Apparatus for Encoding/Decoding

(76) Inventors: Tae Hyeon Kim, Seoul (KR); Hyouk Jean Cha, Kyunggi-do (KR)

Correspondence Address: HARNESS, DICKEY & PIERCE, P.L.C., P.O. BOX 8910, RESTON, VA, 20195, US

(21) Appl. No.: 12/083,380

(22) PCT Filed: Oct. 13, 2006
(86) PCT No.: PCT/KR2006/004125

§ 371 Date: Sep. 18, 2008

Related U.S. Application Data
(60) Provisional application No. 60/789,876, filed on Apr. 7, 2006.
(60) Provisional application No. 60/788,736, filed on Apr. 4, 2006.
(60) Provisional application No. 60/787,173, filed on Mar. 30, 2006.
(60) Provisional application No. 60/757,463, filed on Jan. 10, 2006.
(60) Provisional application No. 60/726,230, filed on Oct. 14, 2005.
(60) Provisional application No. 60/725,655, filed on Oct. 13, 2005.

(30) Foreign Application Priority Data
Jul. 14, 2006 (KR) 10-2006-0066557

(51) Int. Cl. G06T 15/70

(52) U.S. Cl. 345/474

(57) ABSTRACT

The present invention relates to a multimedia data encoding/decoding method and apparatus. The encoding method includes generating a data area including a plurality of media data areas; generating a plurality of track areas corresponding to the plurality of media data areas, respectively; and generating an animation area including at least one of grouping information on an animation effect, opacity effect information, size information on an image to which the animation effect is to be applied, and geometrical transform effect information. According to the present invention, the multimedia data encoding/decoding method and apparatus has an effect of being capable of constructing a slide show by only a small amount of multimedia data. Thus, a time taken to process and transmit the multimedia data can reduce.

### TECHNICAL FIELD

The present invention relates to a method and apparatus for encoding/decoding multimedia data including a video, an audio, and a text, and more particularly, to an encoding/decoding method and apparatus for sequentially reproducing a plurality of media data, thereby constructing a slide show.

### BACKGROUND ART

There occurs a drawback in that a time required for encoding/decoding and a time required for data transmission increase because of a very large amount of data in a multimedia data processing method for integrating and encoding/decoding various formats of media data such as a video, an audio, and a text.

### DISCLOSURE OF INVENTION

### Technical Problem

Accordingly, the present invention is to solve at least the problems and disadvantages of the background art.

The present invention is to provide a multimedia data structure for efficiently encoding/decoding multimedia data, and a multimedia data encoding/decoding method and apparatus using the same.

### Technical Solution

To achieve these and other advantages and in accordance with the purpose of the present invention, as embodied and broadly described, there is provided an encoding method. The encoding method includes generating a data area including a plurality of media data areas; generating a plurality of track areas corresponding to the plurality of media data areas, respectively; and generating an animation area including at least one of grouping information on an animation effect, opacity effect information, size information on an image to which the animation effect is to be applied, and geometrical transform effect information. The track area includes timing information for sequentially reproducing a plurality of media data included in the media data area, and the plurality of media data included in the data area are dependent on one timeline.

In another aspect, there is provided a decoding method. The decoding method includes receiving multimedia data including: a data area including a plurality of media data areas; a plurality of track areas corresponding to the plurality of media data areas, respectively; and an animation area including at least one of grouping information on an animation effect, opacity effect information, size information on an image to which the animation effect is to be applied, and geometrical transform effect information; and sequentially reproducing a plurality of media data included in the media data area, using the information included in the animation area. The plurality of media data included in the data area are dependent on one timeline.

In a further another aspect, there is provided an encoding apparatus. The encoding apparatus includes a data area generator for generating a data area including a plurality of media data areas; a track area generator for generating a plurality of track areas corresponding to the plurality of media data areas, respectively; and an animation area generator for generating an animation area including at least one of grouping information on an animation effect, opacity effect information, size information on an image to which the animation effect is to be applied, and geometrical transform effect information. The track area includes timing information for sequentially reproducing a plurality of media data included in the media data area, and the plurality of media data included in the data area are dependent on one timeline.

In a yet another aspect, there is provided a decoding apparatus. The decoding apparatus includes a data input unit for receiving multimedia data including: a data area including a plurality of media data areas; a media information area including a plurality of track areas corresponding to the plurality of media data areas, respectively; and an animation area including at least one of grouping information on an animation effect, opacity effect information, size information on an image to which the animation effect is to be applied, and geometrical transform effect information; and a reproducing unit for sequentially reproducing a plurality of media data included in the media data area, using the animation effect information included in the animation area. The plurality of media data included in the data area are dependent on one timeline.

In a still another aspect, there is provided a multimedia data structure. The structure includes a file type area having information on a file format; a data area including a plurality of media data areas; a plurality of track areas corresponding to the plurality of media data areas, respectively; and a media information area including an animation area including at least one of grouping information on an animation effect, opacity effect information, size information on an image to which the animation effect is to be applied, and geometrical transform effect information.

### Advantageous Effects

According to the present invention, a multimedia data encoding/decoding method and apparatus has an effect of being capable of constructing a slide show by only a small amount of multimedia data. Thus, a time taken to process and transmit the multimedia data can reduce.

### BRIEF DESCRIPTION OF THE DRAWINGS

The invention will be described in detail with reference to the following drawings in which like numerals refer to like elements.

FIG. 1 is a schematic diagram illustrating an entire structure of multimedia data according to the present invention;

FIG. 2 illustrates a multimedia data structure according to a first exemplary embodiment of the present invention;

FIG. 3 illustrates a multimedia data structure according to a second exemplary embodiment of the present invention;

FIG. 4 illustrates a multimedia data structure according to a third exemplary embodiment of the present invention;

FIG. 5 illustrates timing information on a plurality of media data according to an exemplary embodiment of the present invention;

FIG. 6 is a block diagram illustrating a construction of an encoding apparatus according to an exemplary embodiment of the present invention;

FIG. 7 is a block diagram illustrating a construction of a decoding apparatus according to an exemplary embodiment of the present invention;

FIG. 8 is a flowchart illustrating an encoding method according to the present invention; and

FIG. 9 is a flowchart illustrating a decoding method according to the present invention.

### BEST MODE FOR CARRYING OUT THE INVENTION

Preferred embodiments of the present invention will be described in a more detailed manner with reference to the drawings.

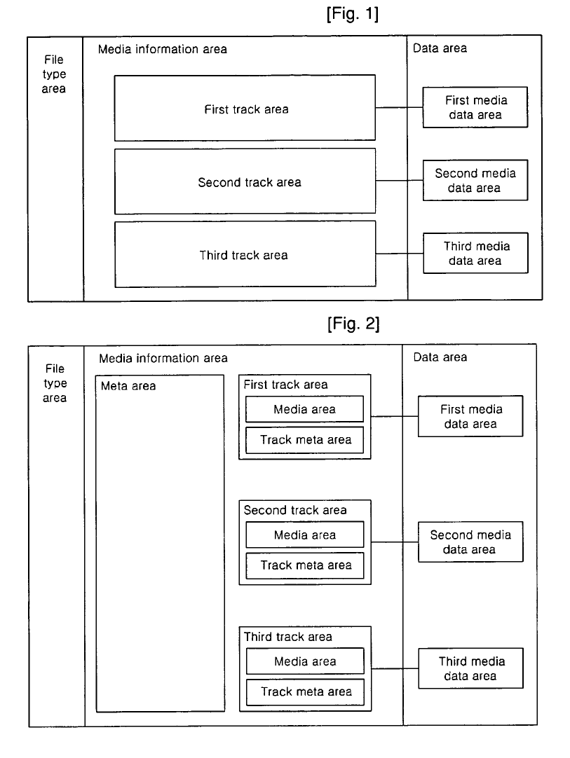

FIG. 1 is a schematic diagram illustrating an entire structure of multimedia data according to the present invention. As shown, a multimedia data file is comprised of a file type area, a media information area, and a data area.

The file type area represents a format of a multimedia data file, and can be expressed in a form or version of the multimedia data file. For example, it can represent that the format of the multimedia data file is an MPEG-4 version 2 format when a file type is “mp42”.

The data area includes a plurality of media data areas. Each of the media data areas includes media data. FIG. 1 shows that the data area includes first, second, and third media data areas. But, the data area can also include four or more media data areas or two or less media data areas. The media data areas can include several types of media data such as image data, audio data, or text data. The image data can be still picture data or moving picture data.

The media information area has information on the media data included in the data area. Referring to FIG. 1, it is desirable that the media information area includes a plurality of track areas that correspond to the plurality of media data areas included in the data area, respectively. In detail, the media information area can include a first track area, a second track area, and a third track area. The first track area has information on the media data included in the first media data area. The second track area has information on the media data included in the second media data area. The third track area has information on the media data included in the second media data area.

The track area included in the media information area can have timing information for sequentially reproducing the media data included in the corresponding media data area, thereby constructing a slide show. For example, the first track area can have information on a duration for reproducing the media data included in the first media data area.

The track area can include several pieces of information on the media data. For example, when the media data is music data, its corresponding track area can include musician information or musical composer information.

FIG. 2 illustrates a multimedia data structure according to a first exemplary embodiment of the present invention. Media information area can include track areas corresponding to media data areas, respectively, and a meta area. The track area can be comprised of a media area and a track meta area.

The meta area is included in the media information area at the same level as those of the track areas. The meta area includes information on the media data included in the data area. The information is information on an attribute for distinguishing the plurality of media data from each other. Desirably, the meta area includes identification (ID) information and position information on the media data. More desirably, the meta area can include name information, contents type information, ID, position information, and size information on the media data.

The following is an example of media data information included in the meta area. In this case, the first media data area includes the N number of JPEG image data, and the second media data area includes MP3 audio data, and the third media data area includes text data.

MP3
item_ID = 1
item_name = <rel. url to mp3>
content_type = audio/mp3
JPEG 1
item_ID = 2
item_name = <rel. url to jpeg 1>
content_type = image/jpeg
...
JPEG N
item_ID = N+1
item_name = <rel. url to jpeg N>
content_type = image/jpeg
Text
item_ID = N+2
item_name = <rel. url to text>
content_type = text

The meta area includes a first meta area and a second meta area. The first and second meta areas can share and include information on the media data. For example, the first meta area can include name and content type information on the media data, and the second meta area can include physical position and size information on the media data.

A handler type of the meta area can be designated to “Isr1” and used.

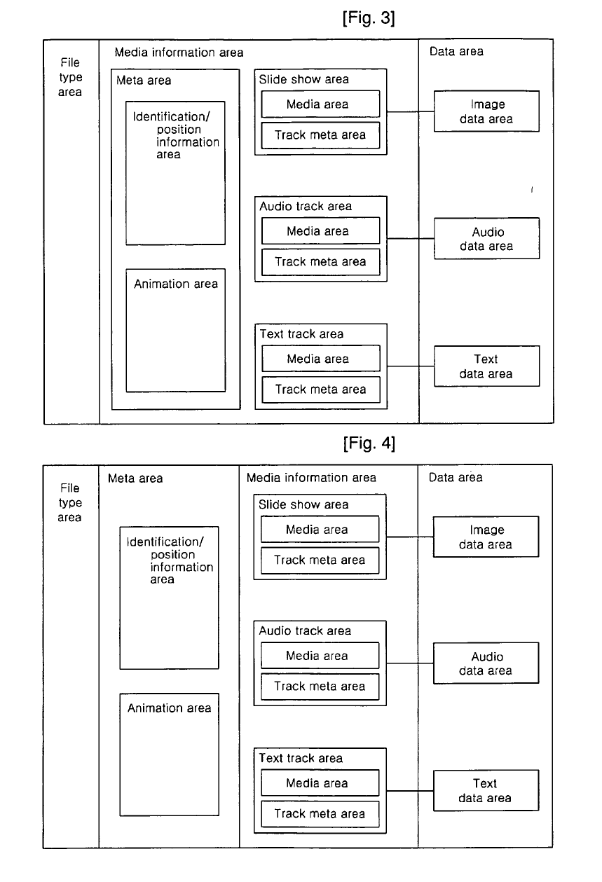

Referring to FIG. 3, a meta area can include an animation area having information on an animation effect to be applied to media data. The animation area can include at least one of grouping information on the animation effect, size information on the media data to which the animation effect is applied, opacity effect information, and geometrical transform information. The grouping information represents a combination of the animation effects to be applied to the media data. The size information describes a variation of an image size when the media data is image data.

The opacity effect information describes an image fade-in or fade-out effect. The geometrical transform information describes effects of transition between images, image scale transform, rotation, and skew, and the like.

The animation area can include information on a motion path of an image or information on motion paths of objects included in the image. The animation area can include image color change information or image form information. The image form information can be a rectangle, a circle, an oval, a line, a polyline, a polygon, and the like. The animation area can include attribute control information for controlling the attribute of the media data, to realize several animation effects applicable to the media data.

As shown in FIG. 4, a meta area can be positioned on a file level, not included in a media information area. In other words, a multimedia data file can be comprised of four areas: a file type area, the meta area, a media information area, and a data area.

The animation area can use a language such as Light-weight Application Scene Representation (LASeR), Scalable Vector Graphics (SVG), or BInary Format for Scene (BIFS), to describe animation effect information. The LASeR, SVG, or BIFS can be realized in an eXtensible Mark-up Language (XML) format or a Binary encoded format.

The following is an example of the animation effect information expressed using the SVG, and expresses the opacity effect information, the scale transform information, and the size variation information.

<svg>
<g id=“Article_Image”>
<animate attributeName=“opacity” calcMode=“linear”
values=“0.00;1.00;1.00;1.00;1.00;1.00;1.00;1.00”
dur=“8.0” repeatDur=“indefinite”/>
<animateTransform attributeName=“transform” type=“scale”
additive=“sum”
calcMode=“linear” values=“1.00 1.00;1.00 1.00;1.00 1.00;1.00 1.00;0.50
1.00;0.00 1.00;1.00 1.00” dur=“8.0” repeatDur=“indefinite”/>
<image width=“200” height=“150” #sampleID = 1 >
</image>
</g>
</svg>

A symbol (<) signifies a start, and a symbol (>) signifies an end. A symbol (/) signifies an end of a context to be defined. For example, a context of <svg> to </svg> is a bundle, and a context of <g id=“Article_image”> to </g> is a bundle, and a context of <image width=“200” height=“150” #sample=1> to </image> is a bundle. The “g” denotes a group and the “Article_image” represents a name of the group (g) in the <g id=“Article_image”>. The “opacity” and “transform” are names of animation attributes or animation effects. The “opacity” and “transform” represent opacity effect and geometrical transform, respectively. A symbol (sum) represents a sum of the animation attributes. A symbol (dur) represents information on the duration for reproducing the image data. A symbol (infinite) signifies indefiniteness.

In case that the image data is regarded as one sample, an image to be realized by the image data (#sampleID=1) having an identification number (ID) of ‘1’ has a width of 200 and a height of 150 in size. The animation effect information expresses an animation effect of linearly (calcMode=“linear”) indefinitely repeating (repeatDur=“indefinite”) a non-opacity variation for the image data (#sampleID=1) from a full non-opacity (value=0.00) to an original non-opacity (value=1.00) during eight seconds (dur=“8.0”). Also, the animation effect information expresses an animation effect of linearly (calcMode=“linear”) indefinitely repeating (repeatDui=“indefinite”) the size variation (“transform, “scale”) of the image data (#sampleID=1) from an original image size (value=1.00) to a half of a horizontal-direction size of an image (value=y; x=1.00; 0.50) during eight seconds (dur=“8.0”). Also, the animation effect information depicts simultaneous implementation (additive=“sum”) of the two animation effects.

The image data comprised of one or more samples is distinguished from each other in a chunk unit. The samples can be arranged in a temporal sequence at each chunk. Each sample included in the chunk has its inherent identification number (ID). The inherent identification number (ID) of each sample can be given starting from ‘1’. The image data (#sampleID=1) having the inherent identification number (ID) of ‘1’ represents, not data itself, its sample.

Referring to FIG. 2, the track area can include the media area, and the track meta area. The media area includes the timing information for sequentially reproducing the media data, thereby constructing the slide show. The track meta area includes the information on the media data.

The timing information on the media data refers to information on the duration or a sequence for reproducing the media data on a timeline. It is desirable that all the media data included in the data area are dependent on one timeline. In other words, it is desirable that the timing information on all the media data included in the data area are expressed on one timeline.

Each of the media data has the timing information, separately. Thus, the durations of reproducing the media data, respectively, cannot be consistent with each other.

The media area can include a first area having the reproduction duration information on the media data; a second area having the position information on the media data; and a third area having the size information on the media data. The media data to be reproduced can be searched using the position and size information included in the second and third areas.

The timing information on the media area can be expressed using the language such as the LASeR, the SVG, or the BIFS. The LASeR, the SVG, or the BIFS can be realized in the XML format or the Binary encoded format.

The timing information on all the media data included in the data area can be included in one media area, for example, the media area of the first track area. Alternately, the media areas can have the timing information on the corresponding media data, respectively. In other words, the media area of the first track area can have the timing information on the first media data, and the media area of the second track area can have the timing information on the second media data, and the media area of the third track area can have the timing information on the third media data.

The track meta area can include information for distinguishing the media data from each other. In other words, the attribute information on the media data can be included in the meta area of the media information area, or included in the track meta area of the track area. In case where the information is included in the meta area, the information on all the media data included in the data area are desirably included in one meta area. In case where the information is included in the track meta area, the information on each media data is desirably divided and positioned in the track meta area included in the corresponding track area. Also, the track meta area can have information on the animation effect.

FIG. 3 illustrates a multimedia data structure according to a second exemplary embodiment of the present invention. An data area can include an image data area, an audio data area, and a text data area. An media information area can include a slide show area having information on image data, an audio track area having information on audio data, and a text track area having information on text data.

The image data included in the image data area can be still picture data or moving picture data. The image data can be data compressed in a format of Joint Picture Expert Group (JPEG), Moving Picture Expert Group (MPEG)-1, 2, or Advanced Video Coding (AVC). In other words, the image data can be data such as various formats of video clips or photographs acquired by a device (not shown) such as a camcorder (not shown) or a portable terminal (not shown).

The audio data included in the audio data area can be music data, accompaniment data, or voice data The audio data can be data compressed in a format of MPEG Layer-3 (MP3) or Advanced Audio Coding (AAC). Alternately, the audio data can be a result obtained by synthesizing the accompaniment data and the voice data. The accompaniment data can be data expressed by only a musical instrument sound excluding a musician's voice in music.

The text data included in the text data area can be data having a character string distinguished in a line unit. In this case, each line can be treated as a sample.

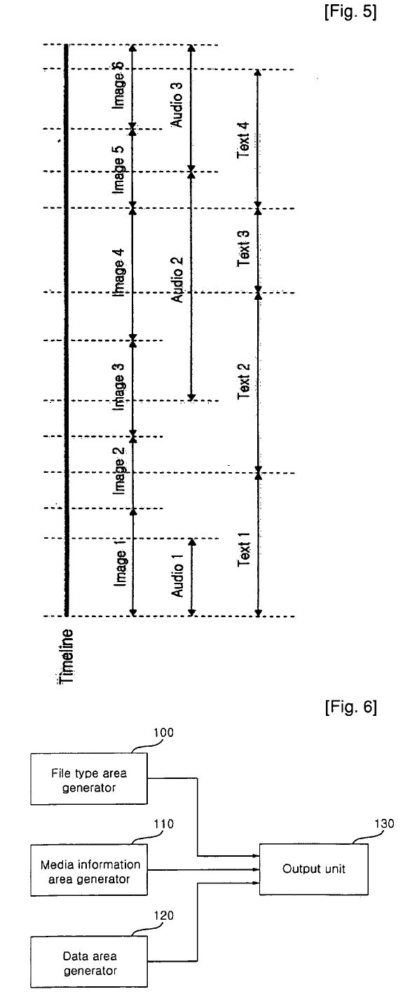

FIG. 5 illustrates timing information on a plurality of media data according to an exemplary embodiment of the present invention. An image data area has six pieces of image data, and an audio data area has three pieces of audio data, and a text data area has four pieces of text data.

As shown in FIG. 5, the media data are dependent on one timeline, but have timing information separately. Therefore, reproduction durations may not be consistent with each other. It is desirable that each of the media data included in the media data area has reproduction duration information, position information, and size information.

A media area of a slide show area can have all of the reproduction duration information, the position information, and the size information on the six pieces of image data, the three pieces of audio data, and the four pieces of text data. In another exemplary embodiment, a media area of a slide show area has reproduction duration information, position information, and size information on six pieces of image data. A media area of an audio track area has reproduction duration information, position information, and size information on three pieces of audio data. A media area of a text track area can have reproduction duration information, position information, and size information on four pieces of text data.

FIG. 6 is a block diagram illustrating a construction of an encoding apparatus according to an exemplary embodiment of the present invention. The encoding apparatus includes a file type area generator 100, a media information area generator 110, a data area generator 120, and an output unit 130.

The file type area generator 100 generates a file type area representing a format of a multimedia data file (Step 300). The media information area generator 110 generates a media information area including information on media data, for example, timing information on the media data included in a data area (Step 310). The data area generator 120 generates a data area including a plurality of media data areas (Step 320).

A sequence of generating the area in the encoding apparatus shown in FIG. 6 is merely one example of an operation of the encoding apparatus according to the present invention. Thus, it is not intended to limit the scope of the present invention. The area generation sequence can be modified, or two or more areas can be simultaneously generated in parallel.

The output unit 130 constructs the generated file type area, media information area, and data area as one file, and outputs the encoded multimedia data (Step 330).

A description of the file type area, the media information area, and the data area is the same as the above description and thus, will be omitted.

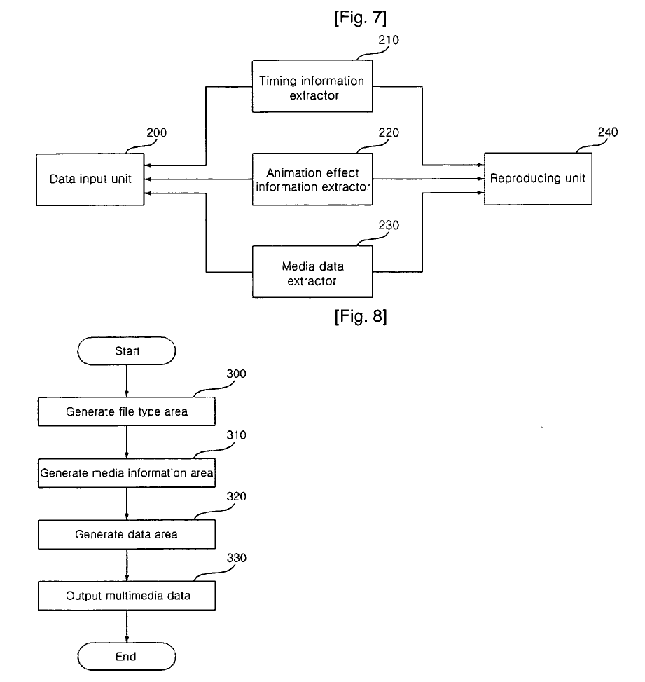

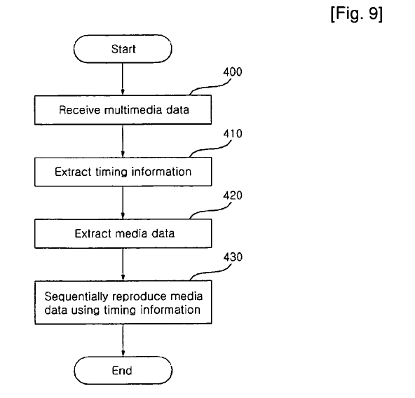

FIG. 7 is a block diagram illustrating a construction of a decoding apparatus according to an exemplary embodiment of the present invention. The decoding apparatus includes a data input unit 200, a timing information extractor 210, an animation effect information extractor 220, a media data extractor 230, and a reproducing unit 240. An operation of the decoding apparatus shown in FIG. 7 will be described with reference to FIG. 9. FIG. 9 is a flowchart illustrating a decoding method according to an exemplary embodiment of the present invention.

The data input unit 200 receives multimedia data (Step 400). The timing information extractor 210 extracts timing information on media data from the received multimedia data (Step 410). It is desirable that the timing information extractor 210 parses a media information area from the received multimedia data and then, extracts the timing information on the media data from a media area included in the media information area.

The media data extractor 230 extracts the media data to be reproduced depending on the extracted timing information from a data area (Step 420). It is desirable that the media data extractor 230 searches the data area for the media data, using size information and position information on the media data included in the media area.

The reproducing unit 240 sequentially reproduces the extracted media data using the extracted timing information, thereby constructing a slide show (Step 430).

In case where there exists animation effect information in an animation area, the animation effect information extractor 220 parses the animation area, and extracts the animation effect information. The reproducing unit 240 can reproduce image data included in an image data area, using the animation effect information. In addition, the reproducing unit 240 reproduce audio data and text data, using the timing information extracted by the timing information extractor 210.

The encoding/decoding method according to the present invention can be programmed for execution in a computer and stored in a computer readable recording medium. The multimedia data having the data structure according to the present invention can be also stored in the computer readable recording medium. The computer readable recording medium includes all kinds of storage units storing data readable by a computer system. The computer readable recording medium is exemplified as a Read Only Memory (ROM), a Random Access Memory (RAM), a Compact-Disk Read Only Memory (CD-ROM), a magnetic tape, a floppy disk, and an optic data storage unit, and includes a unit realized in a format of carrier wave (e.g., Internet transmission). The computer readable recording medium is dispersed to the computer system connecting thereto through a network, and can store and execute a computer readable code in a dispersion method. Function program, code and code segments for realizing a user tracking method can be easily inferred by programmers in a technological field of the present invention.

### INDUSTRIAL APPLICABILITY

As described above, an encoding/decoding method and apparatus according to the present invention can be widely used for a multimedia player or a multimedia coding device for reproducing a plurality of media data, thereby reducing a time taken to process and transmit the multimedia data.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An encoding method comprising:
generating a data area comprising a plurality of media data areas;
generating a plurality of track areas corresponding to the plurality of media data areas, respectively; and
generating an animation area comprising at least one of grouping information on an animation effect, opacity effect information, size information on an image to which the animation effect is to be applied, and geometrical transform effect information,
wherein the track area comprises timing information for reproducing a plurality of media data comprised in the media data area, and the plurality of media data comprised in the data area are dependent on one timeline.

2. The encoding method of claim 1, wherein the animation area comprises at least one of motion information, color change information, attribute control information, and image format information.

3. The encoding method of claim 1, wherein the animation area comprises link information on data corresponding to the image.

4. The encoding method of claim 1, wherein the geometrical transform effect information comprises information on at least one of image translation, scale transform, rotation, skew effects.

5. The encoding method of claim 2, wherein the motion information comprises at least one of motion path information on the image and motion path information on an object comprised in the image.

6. The encoding method of claim 2, wherein the format information comprises at least one of a rectangle, a circle, an oval, a line, a polyline, and a polygon.

7. The encoding method of claim 1, wherein the animation area is described using any one of Light-weight Application Scene Representation (LASeR), Scalable Vector Graphics (SVG), and BInary Format for Scene (BIFS).

8. The encoding method of claim 6, wherein any one of the LASeR, the SVG, and the BIFS is realized in an eXtensible Mark-up Language (XML) format or a binary encoded format.

9. The encoding method of claim 1, wherein a file type area, a media information area comprising the plurality of track areas and a meta area comprising meta information on the media data, and the data area constitute one file, and the file type area has information on a format of the file.

10. The encoding method of claim 9, wherein the plurality of track areas and the meta area are separated from each other.

11. The encoding method of claim 1, wherein the data area comprises an image data area having a plurality of image data, and the media information area comprises a slide show area corresponding to the image data area.

12. The encoding method of claim 11, wherein the slide show area comprises a media area having the timing information on the image data, and a meta area having meta information on the image data.

13. The encoding method of claim 1, wherein the plurality of track areas each comprise a media area having the timing information on the media data, and a meta area having meta information on the media data.

14. The encoding method of claim 1, wherein there exists the timing information on each of the plurality of media data.

15. A decoding method comprising:
receiving multimedia data, the multimedia data comprising: a data area comprising a plurality of media data areas; a plurality of track areas corresponding to the plurality of media data areas, respectively; and an animation area comprising at least one of grouping information on an animation effect, opacity effect information, size information on an image to which the animation effect is to be applied, and geometrical transform effect information; and
reproducing a plurality of media data comprised in the media data area, using the information comprised in the animation area,
wherein the plurality of media data comprised in the data area are dependent on one timeline.

16. The decoding method of claim 15, wherein the animation area comprises at least one of motion information, color change information, attribute control information, and image format information.

17. The decoding method of claim 15, wherein the animation area comprises link information on data corresponding to the image.

18. The decoding method of claim 15, wherein the geometrical transform effect information comprises information on at least one of image translation, scale transform, rotation, skew effects.

19. The decoding method of claim 16, wherein the motion information comprises at least one of motion path information on the image and motion path information on an object comprised in the image.

20. The decoding method of claim 16, wherein the format information comprises at least one of a rectangle, a circle, an oval, a line, a polyline, and a polygon.

21. The decoding method of claim 15, wherein the data area comprises an image data area having a plurality of image data, and the media information area comprises a slide show area corresponding to the image data area.

22. The decoding method of claim 21, wherein the slide show area comprises a media area having the timing information on the image data, and a meta area having meta information on the image data.

23. An encoding apparatus comprising:
a data area generator for generating a data area comprising a plurality of media data areas;
a track area generator for generating a plurality of track areas corresponding to the plurality of media data areas, respectively; and
an animation area generator for generating an animation area comprising at least one of grouping information on an animation effect, opacity effect information, size information on an image to which the animation effect is to be applied, and geometrical transform effect information,
wherein the track area comprises timing information for reproducing a plurality of media data comprised in the media data area, and the plurality of media data comprised in the data area are dependent on one timeline.

24. The encoding apparatus of claim 23, wherein the animation area comprises at least one of motion information, color change information, attribute control information, and image format information.

25. The encoding apparatus of claim 23, wherein the animation area comprises link information on data corresponding to the image.

26. A decoding apparatus comprising:
a data input unit for receiving multimedia data, the multimedia data comprising: a data area comprising a plurality of media data area; a media information area comprising a plurality of track areas corresponding to the plurality of media data areas, respectively; and an animation area comprising at least one of grouping information on an animation effect, opacity effect information, size information on an image to which the animation effect is to be applied, and geometrical transform effect information; and
a reproducing unit for reproducing a plurality of media data comprised in the media data area, using the animation effect information comprised in the animation area,
wherein the plurality of media data comprised in the data area are dependent on one timeline.

27. The decoding apparatus of claim 26, wherein the animation area comprises at least one of motion information, color change information, attribute control information, and image format information.

28. The decoding apparatus of claim 26, wherein the animation area comprises link information on data corresponding to the image.

29. A multimedia data structure comprising:
a file type area having information on a file format;
a data area comprising a plurality of media data areas;
a plurality of track areas corresponding to the plurality of media data areas, respectively; and
a media information area comprising an animation area comprising at least one of grouping information on an animation effect, opacity effect information, size information on an image to which the animation effect is to be applied, and geometrical transform effect information.

30. A computer readable recording medium for recording program for executing, by a computer, a method claimed in claim 1.
